(19) United States
(12) Patent Application Publication
(10) Pub. No.: US 2013/0121769 A1
(43) Pub. Date: May 16, 2013

(54) PIPE LAYING DEVICE

(71) Applicant: Pearse Gately, Sallins (IE)

(72) Inventor: Pearse Gately, Sallins (IE)

(21) Appl. No.: 13/811,836

(22) PCT Filed: Jul. 22, 2011
(86) PCT No.: PCT/EP2011/062616

§ 371 Date: Jan. 23, 2013

(30) Foreign Application Priority Data
Jul. 23, 2010 (GB) 1012349.5

(51) Int. Cl. F16L 1/028

(52) U.S. Cl. CPC F16L 1/028
USPC 405/174

(57) ABSTRACT

When placing pipes, such as pipe sections, into a trench it is desirable to obviate the need for human intervention in an attempt to eliminate the potential for injury to operatives working in a trench caused by trench collapse. Disclosed herein is an automated device (101) having a retractable side boom (104,106) and an associated retractable descendent/downwardly extending boom. The device may further comprise a gripping assembly (108) which is capable of setting a pipe (110) gripped therein to a specific slope or gradient, thus allowing for maximum precision in for example a pipe laying process. The side and descendent booms are operable to deliver a pipe such as a pipe section into a trench.

### FIELD OF THE INVENTION

Disclosed herein is an automated device, for example of the type having a retractable side boom, for laying pipes in a trench.

### BACKGROUND TO THE INVENTION

In conventional practice, pipe laying comprises the steps of excavating a trench and reinforcing the structural integrity of the trench by fitting a trench box therein. The floor of the trench may then be levelled with pea-gravel or other suitable material. A pipe is subsequently lowered into the trench, whereupon labourers disposed within the trench manipulate the lowered pipe so as to engage the pipe with previously laid pipe sections. The remainder of the trench is infilled to completely cover the laid pipe.

Principal amongst the difficulties associated with the traditional pipe laying techniques is that trench work is extremely hazardous. The threat of injury or death to labourers resulting from trench cave-ins is a recurrent possibility. Moreover, the costs associated with enacting protective measures to prevent workers in the trenches from being trapped or seriously injured in the event of trench wall collapse are considerable.

Furthermore, for applications where pipe sections must be set at a specific slope or gradient human intervention in a trench is necessary, with much adjustment required for alignment and achieving a correct gradient, for example a sufficient gradient to have gravity flow within the laid pipe. For example, once the pea gravel bedding has been deposited in the bottom of the trench the operative in the trench must spread and manipulate the gravel precisely to the correct gradient in order to lay the pipe accurately. Such a process is very time consuming. Moreover, when the trench is backfilled localised settlement spots may arise along the pipes as the bedding material is not uniformly spread to support the bottom of the pipe. For the majority of authorities, any depression greater than 20% of the diameter of the pipe is unacceptable and has to be corrected. Obviously such depressions are usually only discovered when a post installation survey is carried out once drain/sewer works are complete. Accordingly, the prior art has provided a number of automated devices to mitigate the aforementioned problems and lessen the extent of human intervention required in the pipe laying process.

For example, U.S. Pat. Nos. 3,989,150, 5,795,101, and 6,280,119 disclose pipe-clamping devices suitable for attachment to existing excavating machinery. The clamping devices are disclosed as being capable of automatically setting a pipe section clamped therein to a specific gradient/slope. The major disadvantage associated with attaching such devices to an excavator resides in the cost associated with operating the excavator. Alternating excavating machinery between the processes of excavation and pipe laying may be considered as a waste of resources given: (i) the operating costs of the excavator; and (ii) the increased length of time it takes to excavate and re-fill a trench as opposed to laying a pipe therein. A separate device that can lay a pipe to a precise slope or gradient working in tandem with an excavator (digging and infilling) has the potential to greatly reduce such costs.

Other issues associated with the use of an excavator modified to lay pipes include that such excavators operate adjacent the trench over uneven volumes of excavated earth thus complicating the task of laying and setting a pipe to a precise gradient or slope. Furthermore, the size and weight of the excavator may increase the risk of trench collapse in different soil types and there is the danger that the excavator falls into the trench. Lastly, the inherent bulk of the excavator arm may not be optimal for the manipulation of or setting of a pipe in narrower trenches, thus necessitating excavation of larger trenches or trenches with sloping sidewalls.

The prior art also provides examples of pipe installation devices operative to function independent of an excavator. International Patent Publication No. WO2005/057067 discloses a moveable pipe laying carrier suitable for straddling a ditch. The device has an apical pipe storing section and a basal pipe advancing conveyor system disposed within the trench. Pipes are lowered by a retractable belt arrangement on to the conveyor system, whereupon rollers on the conveyor system lock the pipe section in to engagement with previously laid pipe sections. This disclosure is silent to laying pipes at a specific gradient or slope. It is primarily concerned with the provision of a conveyor system for forcing pipe sections suspended into the trench into engagement with previously laid pipe sections. It appears the trench floor must be at the required level before the pipes can be laid.

U.S. Pat. No. 3,848,751 discloses a side boom pipe laying device as an improvement over traditional side boom tractors. The device essentially comprises a vehicle unit having an upright mast with a boom thereon. A hoisting reel (terminating in a pipe sling) is moveable along the boom to a particular location by means of a hydraulic arm. A support unit or leg, which depends from the boom supports the other side of the boom. In use, the hoisting reel is moved to a predetermined location along the boom to pick up a pipe which is suspended in the pipe sling. The reel is then moved directly over the trench whereupon the pipe section is lowered therein. The support unit or leg is disposed against a mound of earth on the opposing side of the trench to the device so as to evenly spread the load of a pipe suspended in the pipe sling thereby preventing toppling of the device. This disclosure is silent to laying pipes at a specific gradient or slope nor would it be possible in view of the reel and pipe sling arrangement.

Notwithstanding the state of the art there remains a need for alternative devices capable of minimising human intervention in placing materials in a trench, thereby reducing the potential for injury resulting from trench collapse. Moreover, the device should be capable of setting a pipe secured therein to a specific slope or gradient, thus allowing for maximum precision in any laying or placing process.

### SUMMARY OF THE INVENTION

The present invention provides for a device capable of lowering pipes into a trench. The device can suspend a pipe in position at a precise gradient and then a bedding material such as pea gravel may be poured into the trench so as to support the pipe. This allows the pipe to be fully and uniformly supported thus ensuring accuracy of line and gradient and negating the possibility of localised settlement/depressions of the bedding material.

In a first aspect, the present invention provides a pipe laying device, the device comprising:
a mobile ground engaging unit;
a lateral extensible boom having proximal and distal ends, said proximal end secured to the ground engaging unit and said distal end moveable relative to the ground engaging unit along a longitudinal axis;
a descendent extensible boom having proximal and distal ends, said proximal end secured to the distal end of the lateral extensible boom and said distal end moveable relative to the lateral boom; and
a gripping assembly disposed at the distal end of the descendent boom for gripping a pipe therein,
wherein the lateral and descendent booms are operable to deliver the pipe into a trench.

As used herein, the terms lateral and descendent take their accepted geometric meanings. For example, with reference to the lateral extensible boom, the boom will extend sideways from the mobile ground engaging unit. Similarly, with reference to the descendent extensible boom, the boom will extend downwards away from the lateral boom towards a trench. The mobile ground engaging unit of the device of the present invention is intended to be disposed in an upright orientation only with the lateral extensible boom extending sideways from the mobile ground engaging unit. Thus, artificial circumstances in which the ground engaging unit may be rotated to make the lateral boom descendent and vice versa are not embraced by the present invention.

The term extensible boom is to be understood as indicating a boom that can both increase and decrease in length. The extent of the increase or decrease in length will depend on the need of a given situation.

Advantageously, the device of the present invention provides for an improved working environment. No operatives are required in the trench at any time thereby avoiding the requirement to climb in and out of deep trenches, thus minimising any Health and Safety concerns.

The mobile ground engaging unit of the device of the present invention will be arranged such that when the gripping assembly has a pipe gripped therein toppling of the device is avoided.

Either or both the lateral and descendent extensible booms of the device according to the present invention may be telescopic.

The extensible (or telescopic) booms of the device of the present invention provide for a device that can be located to one side of an excavated trench. The extensible (or telescopic) booms are operable to deliver a pipe into a trench, whilst the load bearing mobile ground engaging unit can be disposed distal to the banks of the trench. By locating the mobile ground engaging unit a sufficient distance away from the trench its mass/weight should not cause partial or total collapse of an unsupported trench. Desirably, with reasonable ground conditions, no associated trench support is required when the device of the present invention is utilised to lay pipes.

Prior art excavator-based pipe laying devices require the excavator to locate near the top of the trench. Accordingly, the excavator may only be successfully deployed if the trench support was in place thereby preventing trench collapse.

The device of the present invention requires no operatives to be disposed within the trench. Advantageously, by avoiding the need to have operatives disposed within the trench, there is no requirement to provide operative working space therein. Accordingly, the requirement for a wide trench is obviated and one need only excavate a narrow trench prior to the steps of laying or placing a pipe therein, thereby saving time. Where the device of the present invention is utilised to lay pipes the trench should be of sufficient width to facilitate the installation of a series of pipe sections therein and subsequent bedding and backfilling/infilling of the trench. Suitable bedding materials include gravel, pea gravel, crushed rock, sand and combinations thereof. The choice of backfill/infill material will depend on the soil type of the excavated trench. Desirably, the trench will be excavated vertically. For example, the trench would not have sloping walls.

Excavating narrower trenches is also more favourable from an environmental perspective. For example, a narrower trench equates to considerably reducing the volume of excavated material to be disposed of/transported away from the site and also considerably reduces the volume of backfill material used to infill the excavated trench.

The device of the present invention may further include a levelling means for:

adjusting the lateral boom such that it extends along a horizontal longitudinal axis; and/or

adjusting the descendent boom such that it extends along a (vertical) plumb-line axis.

As used herein, the terms horizontal and plumb-line take the following meanings. With reference to the lateral extensible boom, any two points on the horizontal longitudinal axis along which the boom extends will be at the same elevation or altitude. Thus, the lateral boom is constrained to extend in an absolute horizontal direction.

Similarly, with reference to the descendent extensible boom extending along a plumb-line axis, any two points on the plumb-line axis along which the boom extends will form a straight line representative of the true vertical.

For example, in one embodiment, the mobile ground engaging unit of the device according to the present invention may further include a levelling means for adjusting the unit such that the lateral boom extends along a horizontal longitudinal axis. As will be appreciated by a person skilled in the art, the lateral boom will have an associated transverse axis lying perpendicular to the longitudinal axis of the lateral boom. The longitudinal and transverse axes may together define a transverse plane splitting the lateral boom into inferior and superior parts. It is desirable that the ground engaging unit is further levelled such that the longitudinal axis of the lateral boom and the transverse axis of the lateral boom are both horizontal (i.e. both axes together defining a horizontal transverse plane). As used herein a horizontal plane will be understood as any plane having three non-collinear points on the plane, wherein all three points are at the same elevation or altitude. In this embodiment, the descendent extensible boom may be fixed in position so as to extend along a vertical axis substantially perpendicular to the (levelled) horizontal transverse plane. Thus, the descendent boom extends along a (vertical) plumb-line axis by referencing the vertical axis as being perpendicular to the horizontal longitudinal axis of the lateral boom and the horizontal transverse axis of the lateral boom.

In a further embodiment, the lateral boom may be secured to the ground engaging unit by means of a biaxial joint. The biaxial joint may allow the lateral boom to be adjusted (or levelled) such that the longitudinal axis of the lateral boom and the transverse axis of the lateral boom are both horizontal (i.e. both axes together defining a horizontal transverse plane). In this embodiment, the descendent extensible boom may be fixed in position so as to extend along a vertical axis substantially perpendicular to the (levelled) horizontal transverse plane. Thus, the descendent boom extends along a (vertical) plumb-line axis by referencing the vertical axis as being perpendicular to the horizontal longitudinal axis of the lateral boom and the horizontal transverse axis of the lateral boom.

In yet a further embodiment, a triaxial joint may be disposed at a junction of the lateral boom and the descendent boom (securing the descendent boom to the lateral boom) wherein said triaxial joint is operable to adjust (or level) the descendent boom so as to guide extension of the descendent boom along a (vertical) plumb-line axis. This may be particularly advantageous where it is not possible to extend the lateral boom along a (levelled) horizontal longitudinal axis.

As used herein biaxial and triaxial joint take their regular meanings, i.e. joints operable to allow for movement around two axes (e.g. x and y axes) and three axes (e.g. x, y and z axes) respectively.

The device of the present invention may comprise any combination of a levelling means within the ground engaging unit, a biaxial joint connecting the lateral boom to the ground engaging unit and a triaxial joint connecting the descendent boom to the lateral boom.

The present invention also embraces extension along axes which are slightly off the absolute horizontal longitudinal axis and/or vertical plumb-line axis provided their deviation from horizontal and vertical is measurable so as to have a referenceable standard against which a gradient setting apparatus (discussed below) can be set to accurately operate. For example, axes within 5 degrees off the absolute horizontal longitudinal axis and/or vertical plumb-line axis may be acceptable.

The lateral and descendent booms of the device according to the present invention may be manufactured from the same or different materials. For example, the lateral and descendent booms may be manufactured so that they are resistant to swaying caused by the passing wind or the mass of a pipe gripped in the gripping assembly. Such sway resistance allows for improved precision in placing a pipe in a trench, such as in a pipe laying process. For example, when setting a pipe section to a specific gradient or slope it is imperative that the lateral and descendent booms are fixed or immobilised so as to deliver the pipe section at a set angle or orientation.

The lateral and descendent booms of the device according to the present invention may be manufactured from a material selected from the group consisting of steel and aluminium. The device of the present invention may have lateral and descendent booms that are the same or different and that can be substantially circular, substantially rectangular or substantially square in cross section. Such an arrangement is particularly advantageous for lateral and descendent telescopic booms.

The device of the present invention may have a mobile ground engaging unit which is mounted on at least one of:
i) a plurality of rollers;
ii) a plurality of tyres; or
iii) a plurality of closed loop tracks.
   Desirably, the rollers or tyres or tracks will easily navigate all terrain types. They should be operable under damp, muddy conditions so as not to get stuck in muddy terrain.

In a yet further embodiment, the device of the present invention may be operated remotely. This may be particularly advantageous from a health and safety perspective. For example, the operator of the device may control or direct the device at a distance from the trench and any heavy machinery.

The pipe gripping assembly of the device of the present invention may be suitable for gripping pipes, and other conduits.

The pipe gripping assembly of present invention may be removable so as to provide for interchange of different gripping assemblies. For example, a pipe gripping assembly may be removed and exchanged with an assembly for gripping a manhole chamber. This may allow for laying a series of pipes in a trench and subsequently connecting a manhole chamber to the previously laid pipe sections.

The pipe gripping assembly may comprise a plurality of pipe gripping jaws. Advantageously, this may aid in spreading the load of a pipe section gripped in the jaws over the entirety of the pipe gripping assembly. Thus, sway of the lateral and descendent booms may be avoided. Moreover, having a plurality of gripping jaws contacting a pipe section may aid in the precise orientation of the pipe section. The pipe gripping jaws may be distributed at even intervals along the pipe gripping assembly. Again, this may further aid in evenly spreading the load of the pipe section and achieving even greater precision when orientating a pipe section.

In one particular embodiment, the pipe gripping jaws may operate independently of one another. This may be particularly advantageous when interlocking a pipe section with a previously laid pipe section.

The present invention may further comprise a pipe connecting means for connecting a previously laid pipe section to a pipe section to be laid.

The pipe connecting means may be a stand-alone device or an integral part of the pipe-laying device.

In one embodiment the pipe connecting means is a pipe connecting clamp. Accordingly, the present invention provides for a clamp for connecting a first pipe to a second pipe, the clamp comprising:

a clamp frame having a first end and a second end;

first and second clamp members mounted on the clamp frame first end, wherein a mechanism mounted on the clamp frame is operable to open and close the first and second clamp members around a pipe receiving space;

a guide member mounted on at least one of the first and second clamp members for guiding the male end of a pipe to be laid into the female end of a pipe clamped in the pipe receiving space; and

a clamp removing member mounted on the second end of the clamp frame, wherein the clamp removing member is coupled to the mechanism such that engagement of the clamp removing member results in the first and second clamp members opening to release a pipe clamped therein.

The guide member may comprise a plurality of sloped projections. For example, the guide member may comprise a plurality of sloped teeth, which define a funnel for guiding the male end of a pipe to be laid into the female end of a clamped pipe. Preferably, the guide member will be mounted on both the first and second clamps.

Advantageously, the guide member of the clamp of the present invention prevents chipping or cracking of pipes during the pipe mating process. If pipes are not properly aligned during the pipe mating process the pipes can be pushed into a mating engagement at force resulting in chipping and cracking of the pipes. Pipes that have been damaged in this way must be discarded. Moreover, failure to detect cracks/chips can be even more costly; once the pipes are in-situ such cracks and chips will inevitably lead to leaks and will have to be replaced.

The clamp of the present invention can be pre-fixed to the female end of a first pipe before it is lowered into a trench. When this first pipe has been laid, the male end of a second pipe to be laid is aligned with and secured in to the female end of the first pipe using the guide member.

When the male end of the second pipe has been secured into the female end of the first pipe the clamp of the present invention can be removed from the trench by engaging the clamp-removing member to release the clamp from the pipe. Preferably, this is achieved without human intervention. For example, the pipe gripping assembly may contain a projection which can be manoeuvred to engage the clamp-removing member. When the pipe gripping assembly is lifted out of the trench it in turn lifts the clamp of the present invention out of the trench.

In one embodiment, the clamp-removing member is a ring. The ring is coupled to the clamp opening and closing mechanism. The projection on the pipe gripping assembly (discussed supra) is insertable into the ring. When the pipe gripping assembly is raised out of the trench, the projection engages the ring to open the clamping mechanism and lift the clamp out of the trench.

The pipe connecting means or pipe connecting clamp of the present invention may be mounted or moveably mounted at a terminus of the pipe gripping assembly. In this context the term terminus refers to an end of the pipe gripping assembly. The pipe connecting means or clamp may be extensible from the end/terminus of the pipe gripping assembly. Advantageously, this may eliminate the need to manually place the clamp of the present invention on the female end of the pipe before it is laid in the trench.

Advantageously, the pipe connecting means also automates the pipe connecting process and is particularly desirable for eliminating the need for operatives to be disposed within a trench.

In a further aspect, the present invention provides for use of a pipe connecting clamp of the present invention in the alignment of a first pipe and a second pipe in a pipe laying process.

In a further embodiment the pipe connecting means may comprise:
i) a first clamp member for clamping a previously laid pipe section; and
ii) a second clamp member for clamping a pipe section to be laid.

As indicated, the pipe gripping assembly may be adjustable to set a pipe gripped therein at a desired angle. The adjustable pipe gripping assembly may adjust the gradient of a pipe gripped therein [such adjustment may be utilised to compensate for the position of the mobile unit]. This is particularly advantageous when laying pipes for conveying fluids, for example gravity flow pipes such as drainage pipes including sewerage pipes. By setting individual pipe sections at a particular angle the overall gradient of the pipes can be such that constant flow (from source to end point) of the fluid material in the pipes is promoted. The maintenance of constant flow along a gradient is important in preventing build-up of particulate materials which eventually may block a given pipe section. Thus, repair of or removal of blocked pipe sections can be lessened or obviated where the pipe system is set at a pre-determined gradient.

Advantageously, the device of the present invention is capable of presetting the gradient of a pipe to be laid in a trench. As indicated supra, the device of the present invention may include a levelling means for adjusting the booms such that the lateral boom extends along a horizontal longitudinal axis and/or the descendent boom extends along a (vertical) plumb-line axis.

By utilising a levelling means in conjunction with a gripping assembly that is configured to orientate a pipe gripped therein at a specific slope or gradient the operator of the device of the present invention can ensure that the gradient of the pipe is set correctly or absolutely relative to a predetermined standard. This may be achieved by referencing the gradient (or slope or angle) set by the gripping assembly relative to the absolute horizontal position of the lateral boom, or the plumb-line vertical position of the descendent boom, as set by the levelling device.

Prior art (pipe) laying devices comprising a robotic gripping assembly attached to the arm of an excavator (or digger) do not provide for such absolute precision. Such prior art documents are silent to referencing an absolute horizontal or vertical axis (for example, as set by a levelling device in the mobile ground engaging unit) to the gradient set by the gripping assembly so as to achieve improved precision.

The device of the present invention may further comprise a free moving joint connecting the descendent extensible boom and the pipe gripping assembly. The free moving joint allows unhindered movement of the pipe gripping assembly. The free moving joint may be a rotational joint. Advantageously, the free moving or rotation joint allows free movement or rotation of the gripping assembly relative to the descendent extensible boom. Thus, the gripping assembly (and therefore the pipe to be laid) may be adjusted so as to be aligned along a theoretical design or gradient line of a trench. Alignment of the gripping assembly may be achieved by any suitable guide means, for example a laser providing a line along which pipes are to be laid. When the male end of a pipe to be laid is secured into the female end of a pipe already in the trench, the gradient and/or position of the pipe to be laid (which is secured in the pipe gripping assembly) can be adjusted using the free moving or rotational joint, which is responsive to movement of the horizontal and vertical booms.

The device of the present invention may have a gripping assembly that is adjustable to orientate a pipe gripped therein at a specific slope or gradient.

The pipe gripping assembly may comprise an adjustable gradient setting apparatus to orientate (or adjust) a pipe gripped therein at a specific slope or gradient. For example, the gradient setting apparatus may comprise:
i) a first plate member secured to the descendent extensible boom;
ii) a second plate member secured to the gripping assembly; and
iii) a hinge means attached to said first and second plate members, wherein said hinge means is operable to move said second plate relative to said first plate so as to set a pipe gripped within the gripping assembly at a specific gradient or slope.

The device of the present invention may further comprise an auxiliary guide means for enhancing the precision of the device when placing a pipe in a trench. The auxiliary guide means may be selected from the group consisting of a laser, a Global Positioning System (GPS) and combinations thereof. For example, to ensure proper alignment of a pipe section, a laser target may be mounted on the pipe gripping assembly or within the pipe sections.

The device of the present invention may further comprise a receptacle for bedding or infilling material and a discharger for discharging the bedding or infilling material from the receptacle. The receptacle may be a hopper. The bedding or infilling material may be a material selected from the group consisting of gravel, pea gravel, crushed rock, sand and combinations thereof.

The device of the present invention is particularly attractive in that it can save time, it decreases the amount of human labour required for placing materials (such as pipe sections) in a trench, and thus it reduces the associated costs. Moreover, by utilising the device of the present invention in a pipe laying process the operator can further save costs on waste disposal and infilling materials as the excavated trench can be narrower than the trenches that must be provided for prior art pipe laying devices.

In a further aspect the present invention provides for a method of laying a pipe in a trench comprising the steps of:
i) providing a plurality of pipe sections; and
ii) providing a device according to the present invention,
wherein the device is operable to deliver said pipe sections into the trench.

The method may further comprise the step of:
iii) providing a manhole chamber and connecting the manhole chamber to previously laid pipe sections.

The present invention further provides for a method of laying pipes (or aligning pipes) in a trench, the method comprising the steps of:
i) attaching a clamp according to the present invention to a female end of a first pipe section;
ii) placing the pipe section into the trench, and fixing the pipe section in place; and
iii) placing a second pipe section into the trench and mating a male end of said second pipe section into the female end of said first pipe section.

With reference to the above method, the device of the present invention may be operable to place said pipe sections into the trench. The step of fixing the pipe section in place may comprise bedding the pipe in a material selected from the group consisting of gravel, pea gravel, crushed rock, sand and combinations thereof. The method may additionally comprise the step of removing the clamp of the present invention from the first pipe section.

The method may further comprise providing an alignment means for guiding alignment of pipe sections in the correct position and at the correct gradient. The alignment means may be a laser.

When the second pipe section has been placed in the trench at the correct position or gradient, it too can be fixed in place utilising an appropriate bedding material. Iterations of the above process can be completed to lay a plurality of pipes at a desired gradient.

Advantageously, the pipe laying method of the present invention allows for facile alignment of pipes and avoids the problems associated with chipping and cracking caused by mating pipes that are inappropriately aligned.

With reference to either pipe laying method, it will be appreciated by a person skilled in the art that the method may further comprise aligning the pipe at a specific gradient or slope using a laser sight or other suitable alignment means.

In yet a further aspect, the present invention provides for a kit comprising:
i) a pipe laying device according to the present invention; and
ii) a clamp according to the present invention.

The invention also provides for a pipe section having a clamp according to the present invention attached thereto.

Where suitable, it will be appreciated that all optional and/or preferred features of one embodiment of the invention may be combined with optional and/or preferred features of another/other embodiment(s) of the invention.

### BRIEF DESCRIPTION OF THE DRAWINGS

Additional features and advantages of the present invention are described in, and will be apparent from, the detailed description of the invention and from the drawings in which:

FIG. 1 illustrates an isometric view of a pipe laying device according to the present invention;

FIG. 2 illustrates an end view of a pipe laying device according to the present invention lowering a pipe section into a trench;

FIG. 3 illustrates a side view of a pipe laying device according to the present invention having a pipe section gripped therein;

FIG. 4 illustrates a magnified view of the gradient setting apparatus of the pipe gripping assembly;

FIG. 5 illustrates a side on view of the pipe connecting clamp of the present invention; and

FIG. 6 illustrates a front-end view of the pipe connecting clamp of the present invention.

### DETAILED DESCRIPTION OF THE INVENTION

It should be readily apparent to one of ordinary skill in the art that the pipe laying example disclosed herein below represents a generalised example only, and that other arrangements and methods capable of reproducing the invention are possible and are embraced by the present invention.

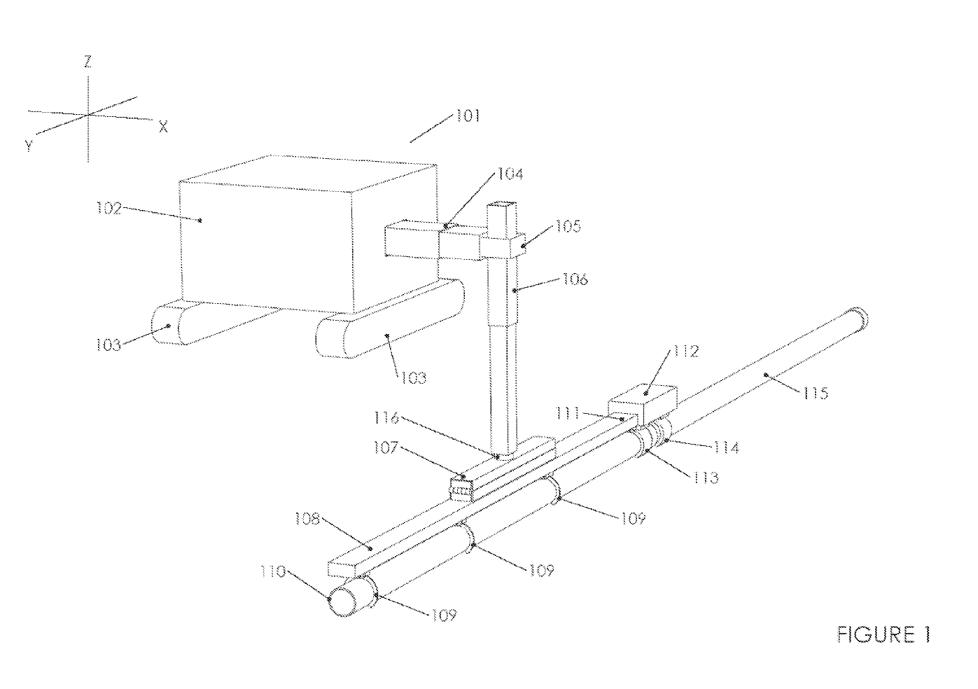

FIG. 1 provides an isometric view of the device 101 of the present invention. The ground engaging unit 102 of the device 101 is mounted on a pair of closed loop tracks 103. The tracks 103 will be suitable for navigating all terrain types. The ground engaging unit 102 may be rotatable relative to the tracks 103 around the vertical z-axis. Extending from the unit 102 is a lateral telescopic boom 104. In the embodiment shown, the unit 102 is levelled such that the lateral telescopic boom 104 has a longitudinal axis parallel to the x-axis and a transverse axis parallel to the y-axis, i.e. the longitudinal and transverse axes define a horizontal transverse plane that is parallel to the xy plane. A first end [not shown] of the lateral boom 104 is secured within and immovable from the unit 102.

Disposed and secured within the second end 105 of the horizontal boom 104 is a descendent telescopic boom 106. The descendent telescopic boom 106 extends along an axis substantially parallel to the vertical z-axis. The descendent telescopic boom 106 terminates in a rotational joint 116 which connects the descendent boom to the pipe gripping assembly 108. The gradient setting apparatus 107 sits on a pipe gripping assembly 108. The pipe gripping assembly has a plurality of pipe gripping jaws 109 depending therefrom. The jaws 109 securely grip a pipe section 110 therein.

The pipe gripping assembly terminates at end 111 with a pipe connecting element 112. The pipe connecting element 112 has first and second gripping jaws 113 and 114. Jaw 114 engages and secures a previously laid pipe section 115. Jaw 113 engages and secures pipe section 110, i.e. the pipe section to be laid. The jaws 113 and 114 facilitate efficient interlocking of pipe sections 110 and 115.

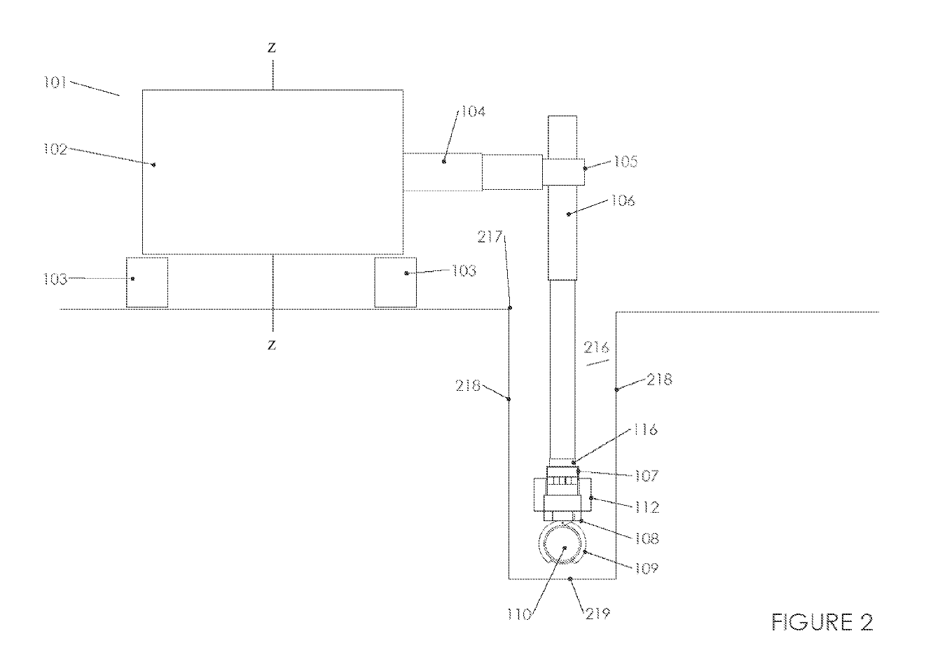

FIG. 2 provides an end on view of the device 101 in use, laying a pipe section 110 in an excavated trench 216. The trench comprises a trench edge 217, trench walls 218 and a trench floor 219. The main load bearing component, the ground engaging unit 102 mounted on tracks 103, is located a distance from trench edge 217. Thus, the possibility of trench collapse is minimised and the need for a trench box or some other form of trench support is obviated. Lateral boom 104 extends from the unit 102 along an axis perpendicular to the z-axis. When the horizontal boom 104 is disposed above trench 216 descendent boom 106 extends telescopically down into trench 216.

As descendent boom 106 is lowered towards trench floor 219 pipe section 110, secured within gripping jaws 109 of pipe gripping assembly 108, is also lowered into trench 216. The gradient setting apparatus 107 is operable to set the pipe 110 at a specific gradient or angle within the trench 216. Pipe connecting element 112 enables the pipe laying device 101 to interlock pipe section 110 with an previously laid pipe section [not shown].

The rotation joint 116 allows rotation of the pipe gripping assembly 108 relative to the descendent telescopic boom 106. When the need arises, the pipe gripping assembly 108 and pipe section 110 gripped therein may be rotated so as to align pipe section 110 along a theoretical design line (provided for example by a laser) of the trench 216 before a pipe is lowered into the trench 216.

The device 101 is responsive to remote operation. The booms 104/106, pipe gripping assembly 108 and gradient setting apparatus 107 can be controlled remotely to deliver pipe section 110 into trench 216 without the need for operatives/labourers within the trench. Thus, health and safety considerations and costs are greatly reduced.

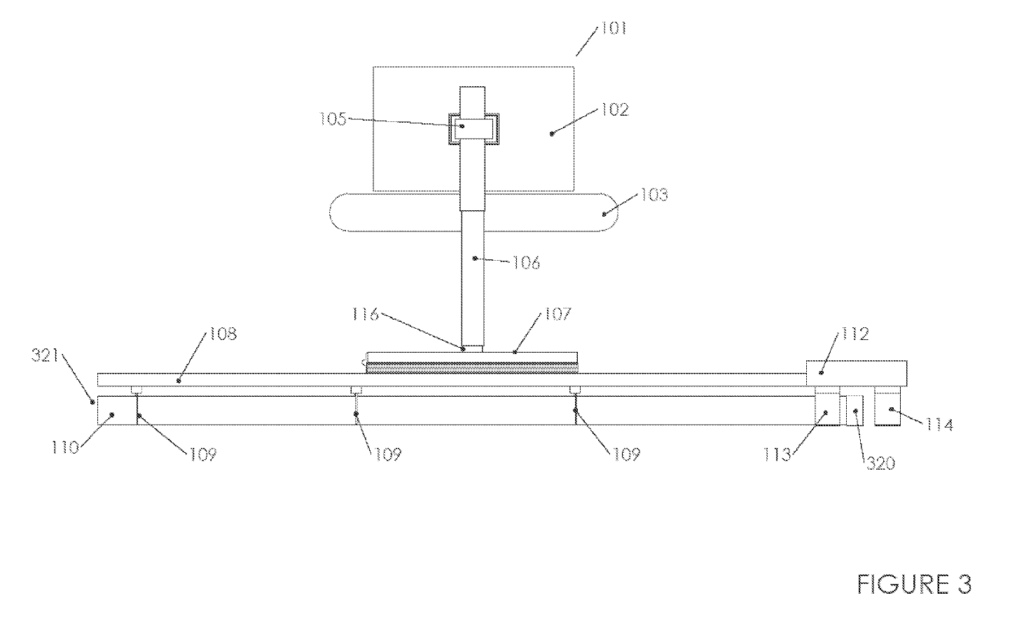

In FIG. 3 a side-on view of the pipe laying device 101 of FIG. 1 is provided. The pipe gripping jaws 109 have a pipe section 110 secured therein. The pipe section 110 has a bell end 320 and a spigot end 321. The bell end 320 of pipe section 110 is secured to pipe connection element 112 by means of jaw 113.

In use, pipe section 110 is lowered into the trench at a specific gradient, by means of gradient adjuster 107. As pipe section 110 approaches a previously laid pipe section in a trench gripping jaw 114 is operable remotely, for example using a control panel, and independent of jaw 113 to secure the previously laid pipe section to the connection assembly. The spigot end of the previously laid pipe is secured to the pipe connection element 112 so as to interlock said spigot end with the bell end 320 of pipe section 110.

Once laid at the desired gradient, the trench can be at least partially infilled to keep the pipe at the desired gradient and elevation. The jaws 109, 113 and 114 can be released to free the pipe gripping assembly so as to begin another iteration of the pipe laying process.

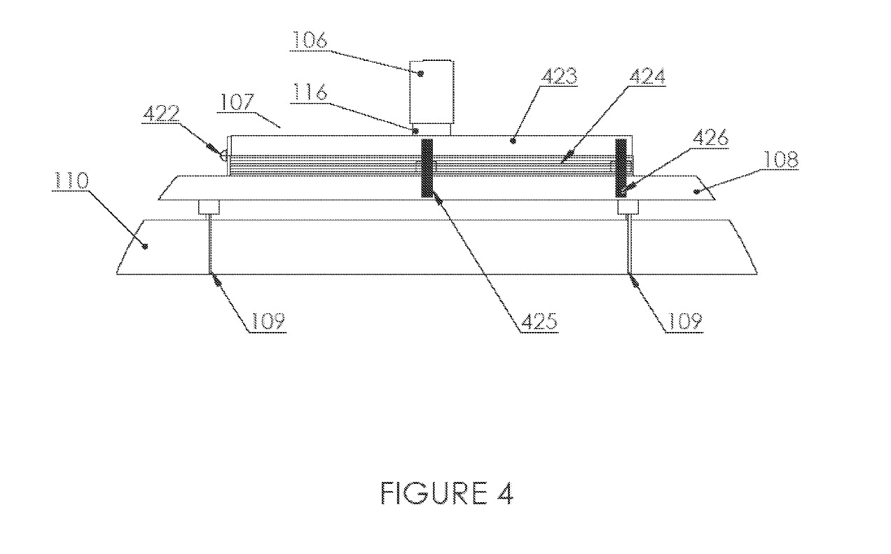

FIG. 4 provides a magnified view of the gradient setting apparatus 107. A hinge 422 is fixed to upper plate 423 and lower plate 424. A hinge may be disposed at either end of plates 423 and 424. The upper plate 423 is attached to descendent telescopic boom 106 by means of rotational joint 116. The lower plate 424 is secured to pipe gripping assembly 108. Sliding adjustable brackets 425 and 426 are bolted to the upper plate 423 and the pipe gripping assembly 108. The first sliding adjustable bracket 425 is positioned at the midpoint of upper plate 423. The second sliding adjustable bracket 426 is positioned at the end of upper plate 423 opposite hinge 422.

The hinge 422 is motorised. A signal (for example electronic or infrared) may be sent to the motorised hinge 422 causing it to open a predetermined amount/degree. As the hinge 422 opens lower plate 424 is urged away from upper plate 423. The force generated by the movement of lower plate 424 causes sliding adjustable brackets 425 and 426 to extend or slide downwardly, the extent of descent being determined by the degree to which hinge 422 opens. Given that pipe gripping assembly 108 is secured to lower plate 424, as lower plate 424 descends so does pipe gripping assembly 108.

In the embodiment shown in FIG. 4 pipe gripping assembly 108 and associated pipe gripping jaws 109 have a pipe section 110 secured therein. Accordingly, upper and lower plates 423 and 424 in combination with hinge 422 and sliding adjustable brackets 425/426 are operable to set or orientate pipe section 110 at a specific gradient or angle within a trench.

The ability to lay a pipe section 110 at a predetermined angle is particularly advantageous when laying pipes for conveying fluids, for example gravity flow pipes, such as drainage pipes and including sewerage pipes. By controlling the overall gradient of the pipes a constant flow (from source to end point) of the fluid material in the pipes can be maintained. The maintenance of constant flow along a gradient is important in preventing build-up of particulate materials which eventually may block a given pipe section. Thus, repair of or removal of blocked pipe sections can be lessened or obviated where the pipe system is set at a pre-determined gradient.

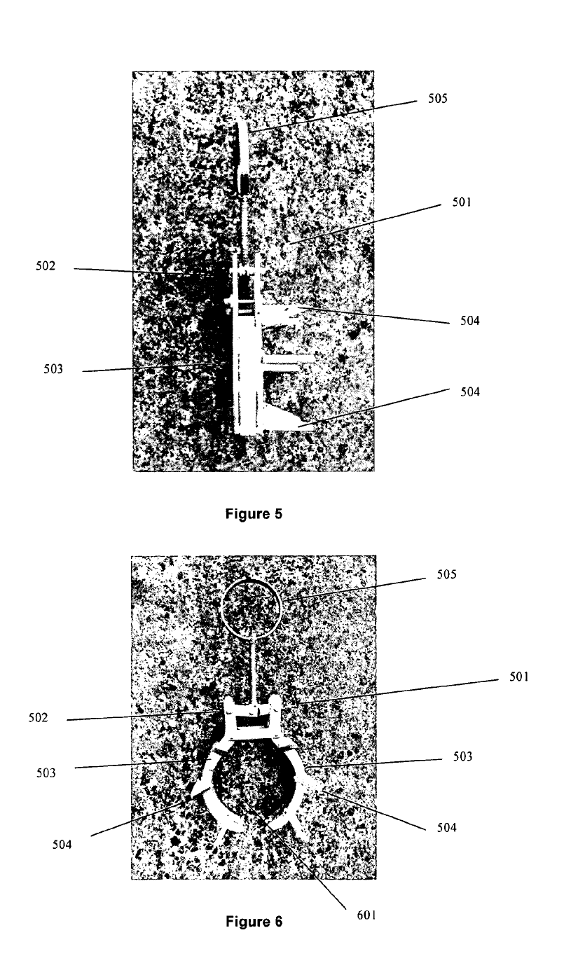

FIGS. 5 and 6 provide views of the pipe-connecting clamp 501 of the present invention. In the embodiment shown the pipe connecting means is a stand-alone device. The pipe connecting clamp comprises a clamp frame 502 on which clamp members 503. A mechanism mounted on the clamp frame is operable to open and close the clamp members 503 around a pipe receiving space 601. A guide member, shown as sloped teeth 504, is mounted on clamp members 503. A clamp removing member, illustrated as a ring 505 is mounted on the clamp frame 502. T

Sloped teeth 504 define a funnel for guiding the male or spigot end of a pipe to be laid into the female or bell end of a clamped pipe (not shown). By aligning pipes using the funnel defined by teeth 504 the clamp of the present invention prevents chipping or cracking of pipes during the pipe mating process. The clamp removing ring 505 is coupled to the clamp opening and closing mechanism such that engagement of the ring results in the clamp members 503 opening to release a pipe clamped therein.

Ring 505 could be engaged by a projection on the pipe gripping assembly. The projection can be maneuvered to insert into the ring 505. When the pipe gripping assembly is raised out of the trench, the projection engages the ring to open the clamping mechanism and lift the clamp out of the trench.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A pipe laying device, the device comprising:
a mobile ground engaging unit;
a lateral extensible boom having proximal and distal ends, said proximal end secured to the ground engaging unit and said distal end moveable relative to the ground engaging unit along a longitudinal axis;
a descendent extensible boom having proximal and distal ends, said proximal end secured to the distal end of the lateral extensible boom and said distal end moveable relative to the lateral boom; and
a gripping assembly disposed at the distal end of the descendent boom for gripping a pipe therein,
wherein the lateral and descendent booms are operable to deliver the pipe into a trench.

2. A device according to claim 1 wherein the lateral and descendent extensible booms are telescopic.

3. A device according to claim 1 further including a levelling means for:
i) adjusting the lateral boom such that it extends along a horizontal longitudinal axis; and/or
ii) adjusting the descendent boom such that it extends along a plumb-line axis.

4. A device according to claim 1 wherein the mobile ground engaging unit includes a levelling means for adjusting the unit such that the lateral boom extends along a horizontal longitudinal axis.

5. A device according to claim 1 wherein the lateral extensible boom further comprises a transverse axis lying perpendicular to the longitudinal axis, and wherein the mobile ground engaging unit is levelled such that the longitudinal axis of the lateral boom and the transverse axis of the lateral boom are both horizontal.

6. A device according to claim 1 wherein the lateral boom is secured to the ground engaging unit by means of a biaxial joint, said biaxial joint being operable to adjust the lateral boom such that it extends along a horizontal longitudinal axis.

7. A device according to claim 1 wherein the lateral extensible boom further comprises a transverse axis lying perpendicular to the longitudinal axis, and wherein the biaxial joint adjusts the lateral boom such that the longitudinal axis of the lateral boom and the transverse axis of the lateral boom are both horizontal.

8. A device according to claim 1 wherein the descendent extensible boom is fixed to the lateral boom so as to extend along a vertical axis substantially perpendicular to the horizontal longitudinal axis and horizontal transverse axis.

9. A device according to claim 1 further comprising a triaxial joint disposed at a junction of the lateral boom and the descendent boom wherein said triaxial joint is operable to guide extension of the descendent boom along a vertical plumb-line axis.

10. (canceled)

11. A device according to claim 1 wherein the lateral and descendent booms are manufactured from materials selected from the group consisting of steel and aluminium.

12. (canceled)

13. A device according to claim 1 wherein the lateral and descendent booms are the same or different and can be substantially circular, substantially rectangular or substantially square in cross section.

14. A device according to claim 1 wherein the gripping assembly is adjustable to orientate a pipe gripped therein at a specific slope or gradient.

15. A device according to claim 1 further comprising a free moving joint connecting the descendent extensible boom and the pipe gripping assembly for rotation of the gripping assembly relative to the descendent extensible boom.

16. A device according to claim 15 wherein the free moving joint is a rotation joint.

17. A device according to claim 1 wherein the gripping assembly comprises an adjustable gradient setting apparatus to orientate a pipe gripped therein at a specific slope or gradient.

18. A device according to claim 1 wherein the gripping assembly comprises an adjustable gradient setting apparatus to orientate a pipe gripped therein at a specific slope or gradient, the gradient setting apparatus comprising:
i) a first plate member secured to the descendent telescopic boom;
ii) a second plate member secured to the gripping assembly; and
iii) a hinge means attached to said first and second plate members, wherein said hinge means is operable to move said second plate relative to said first plate so as to set a pipe gripped within the gripping assembly at a specific gradient or slope.

19. A device according to claim 1 wherein the mobile ground engaging unit is mounted on at least one of:
i) a plurality of rollers;
ii) a plurality of tyres; or
iii) a plurality of closed loop tracks.

20. A device according to claim 1 wherein the device is operated remotely.

21. A device according to claim 1 wherein the pipe gripping assembly comprises a plurality of pipe gripping jaws.

22-23. (canceled)

24. A device according to claim 1 further comprising a pipe connecting means for connecting a previously laid pipe section to a pipe section to be laid.

25-26. (canceled)

27. A device according to claim 1 further comprising a pipe connecting means for connecting a previously laid pipe section to a pipe section to be laid, wherein the pipe connecting means comprises:
i) a first clamp member for clamping a previously laid pipe section; and
ii) a second clamp member for clamping a pipe section to be laid.

28. (canceled)

29. A device according to claim 1 further comprising a receptacle for bedding material and a discharger for discharging the bedding material from the receptacle.

30-36. (canceled)

37. A method of laying pipes in a trench comprising the steps of:
i) providing a plurality of pipe sections; and
ii) providing a device according to claim 1,
wherein the device is operable to deliver said pipe sections into the trench.

38-41. (canceled)
